(19) United States
(12) Patent Application Publication
(10) Pub. No.: US 2014/0282356 A1
(43) Pub. Date: Sep. 18, 2014

(54) System Integration Techniques

(71) Applicant: SimuQuest, Inc., Ann Arbor, MI (US)

(72) Inventors: John S. Mills, Ann Arbor, MI (US); Raymond C. Turin, Grosse Pointe Park, MI (US); Christopher A. Myers, Ann Arbor, MI (US)

(73) Assignee: SimuQuest, Inc., Ann Arbor, MI (US)

(21) Appl. No.: 14/209,334

(22) Filed: Mar. 13, 2014

Related U.S. Application Data
(60) Provisional application No. 61/792,543, filed on Mar. 15, 2013.

(51) Int. Cl. G06F 9/44; G06F 17/30

(52) U.S. Cl. CPC G06F 8/70; G06F 17/30958
USPC 717/101

(57) ABSTRACT

One aspect of the disclosure provides a method including generating a graph database that stores records representing objects in a software development project. Each record is a node in a graph. The graph database further stores a set of relationships, with each relationship defining an edge between two related objects. The method also includes receiving a request for an analysis report corresponding to a specific object with respect to at least a portion of the software development project. The method also includes identifying one or more relationships of the specific object based on the set of relationships. The method includes determining a set of related objects that have a relationship to the specific object based on the identified relationships. The method further includes generating the analysis model based on the specific object, the identified relationships and the set of related objects. The method also includes providing the analysis model.

### PRIORITY CLAIM

This U.S. patent application claims priority to U.S. Provisional Application Ser. No. 61/792,543 filed on Mar. 15, 2013. The disclosure of this prior application is considered part of the disclosure of this application and are hereby incorporated by reference in their entirety.

### BACKGROUND

Complex embedded control systems such as an automotive powertrain control system typically involve thousands of data objects (variables and calibratable parameters) and artifacts (embedded program code, feature model, test cases, etc.), using or referring to these objects. During development, the sheer number of objects and artifacts makes it impractical to ensure the proper use of data objects (throughout different artifacts) as well as to keep track of and analyze the general relationships between data objects and development artifacts.

The lack of traceability and control over the usage of data objects in various control artifacts not only impedes the expedient conclusion of a development program but also may introduce defects that are very difficult to find and resolve.

### SUMMARY

One aspect of the disclosure provides a method including generating, at a processing device, a graph database that stores a plurality of records representing a plurality of objects in a software development project. Each record in the graph database represents an object in the software development project and is a node in a graph. The graph database further stores a set of relationships, with each relationship defining an edge between two related objects. The method also includes receiving, at the processing device, a request for an analysis report corresponding to a specific object with respect to at least a portion of the software development project. The method also includes identifying, at the processing device, one or more relationships of the specific object based on the set of relationships. The method includes determining, at the processing device, a set of related objects that have a relationship to the specific object based on the identified relationships. The method further includes generating, at the processing device, the analysis model based on the specific object, the identified relationships and the set of related objects. The method also includes providing the analysis model, at the processing device.

Implementations of the disclosure may include one or more of the following features. In some implementations, each relationship in the set of relationships defines a type of the relationship between the two related objects. Generating the analysis model may include rendering, at the processing device, a visual graph based on the specific object, the set of related objects, and the set of relationships. Each relationship is an edge in the graph model between two graphed objects. Additionally or alternatively, each relationship may define a type of the relationship, and the type of each relationship may be displayed in the visual graph.

In some examples, identifying the one or more relationships includes identifying, at the processing device, a specific relationship of the specific object based on the set of relationships. The method may also include identifying, at the processing device, a directly related object indicated by the specific relationship. The method may further include traversing, at the processing device, other relationships of the directly related object to identify indirectly related objects of the specific object. The other relationships may be included in the one or more relationships.

In some examples, identifying the one or more relationships includes identifying, at the processing device, one or more specific relationships of the specific object. The method may also include identifying, at the processing device, one or more directly related objects based on the one or more specific relationships. The method may further include iteratively traversing, at the processing device, other relationships of the directly related objects to identify related objects in the portion of the software development projects. Additionally or alternatively, the analysis report may be based on the one or more specific relationships, the one or more directly related objects, the one or more other relationships, and the indirectly related objects.

In some implementations, creating the graph database includes receiving one or more artifacts and extracting a plurality of objects from the artifacts, at the processing device. For each object, the method includes parsing the artifact to identify a reference to another object, at the processing device. When a reference to the other object is identified, the method includes a new relationship between the object and the other object in the set of relationships, at the processing device. Each object and relationship in the graph database is respectively assigned a unique identifier.

In some examples, creating the graph database includes determining, at the processing device, a first plurality of objects and relationships corresponding to a first portion of the software development project and a second plurality of objects and relationships corresponding to a second portion of the software development project. The method also includes determining, at the processing device, a union set of objects of the first and second pluralities of objects, such that there are no duplicate objects in the union set of objects. The method further includes determining, at the processing device, a union set of relationships based on the first and second pluralities of relationships, such that there are no duplicate relationships in the union set of relationships. The graph database comprises the union set of objects and the union set of relationships.

In some examples, the specific object represents one of a signal, parameter, a requirement, a feature, a test suite, a test case, a test case waveform, a test harness, a model, a model subsystem, a model block, a file, a statement, a function, a declaration, a definition, a user identity, and a time instance. In some examples, the specific object is a time instance and the relationships between the time instance and the other objects indicates that the other objects were relevant to the software development project at a time corresponding to the time instance.

In some implementations, the method includes receiving, at the processing device, a second request to view a previous state of the specific object and retrieving, at the processing device, a revision history indicating a current state of and a set of changes that have been made to one or more of the objects, including the specific object. The method also includes determining, at the processing device, the previous state of the specific object and the set of related objects based on the revision history. The method can further include generating, at the processing device, the second analysis model indicative of the state based on the specific object and the set of related objects at the previous state and providing, at the processing device, the second analysis mode.

In some examples, generating the analysis model includes generating, at the processing device, a subgraph based on the specific object, the identified relationships, and the set of related objects. The method also includes performing, at the processing device, one or more transformations on the subgraph to obtain another subgraph based on the contents of the request. Additionally or alternatively, one or more transformations may be selected from the group including: Node-to-Edge conversion, Edge-to-Node conversion, Edge aggregation, Node aggregation, Node creation, Edge creation, Node removal, and Edge removal. According to some implementations, the software development project is a development and testing of a real-time vehicle control system.

### DESCRIPTION OF DRAWINGS

FIG. 1 is a drawing of a system integration server in operation communication with a plurality of computing devices.

FIG. 2 is a drawing of an example arrangement of records in a graph database.

FIG. 3 is a schematic illustrating example components of the system integration server.

FIG. 4 is a flow chart illustrating a method for creating and/or updating a graph database.

FIG. 5 is a flow chart illustrating a method for providing the relationships of an object in a software development model.

Like reference symbols in the various drawings indicate like elements.

### DETAILED DESCRIPTION

FIG. 1 illustrates a system integration server 10 in communication with N computing devices 20 (e.g., computing device 20-1, 20-2 . . . 20-N). The system integration server 10 includes a graph database 30 and a revision database 40. A computing device 20 can provide one or more artifacts (e.g., code, documentation, spreadsheets, software requirements, scripts, and/or test suites, relating to a software development project to the system integration server 10). In collection, the N computing devices 20 can provide the entire collection of artifacts relating to the software development project. A software development project can include any computer code, software requirements documents, test suites, script, or any other suitable file that developed or used in the development of software or a software model. For example, a software development project can be a project for developing and testing a real-time control system (e.g., a real-time control system of a vehicle). The system integration server 10 analyzes the artifacts and extracts one or more objects therefrom. An object can be any entity of interest in the artifact. Examples of objects include, but are not limited to, a signal, a parameter, a requirement, a feature, a test suite, a test case, a test case waveform, a test harness, a model, a model subsystem, a model block, a file, a statement, a file, a function, a declaration, a definition, a user identity, and a time instant. In some implementations, some of the operations described above are performed by the computing devices 20. For instance, the computing device 20 can process the one or more artifacts and extract one or more objects from the artifacts and the relationships discovered between the objects within the artifacts. The computing device 20 can then transmit this information to the system integration server 10.

The system integration server 10 supports the creation or modification of all objects (including artifact references) required to manage complex control software development programs (both within a model-based as well as a traditional development framework). These objects can involve data objects (signals, parameters, tables, etc.), data characterization objects (e.g., custom data type objects), data administration objects (tags, transforms, etc.), and artifact objects (models, features, architecture components, code file references, etc.). Objects can be defined locally (local ownership and usage) or globally (shared usage). Shared objects may be under version control and require ownership privileges in order to gain accessed and in order to make changes thereto. Objects under version control that are not subject to access restrictions can be public objects. Objects with limited access can be private objects. The system integration server 10 can manage these ownership privileges as an intrinsic part of the objects. Shared objects (public and private) are organized in pools and can reside in remote data repositories (data centers) and can be accessed via the network. The system integration server 10 intrinsically supports programs with locally distributed development teams. Each member of a team can create or access relevant data and use the data as needed for their specific development task (e.g. development of a control feature). Local changes to the objects can be pushed back to the remote repository and thus are propagated into all artifacts that use these objects. Since shared data may be under version control, any arbitrary state in the development history of that data can be easily recreated. This minimizes any fear to alter proven work products and, for example, experiment with new and/or improved control algorithms.

The system integration server 10 is configured to receive artifacts from the computing devices 20, to extract objects from the artifacts, and to create and maintain a graph database 30 based on the received objects. In its broadest sense, the term “graph” as used throughout this disclosure means a data structure (often, but not necessarily, an abstract data type), irrespective of how the data structure is presented to a user. In some instances, the data structure is presented to the user as edges and nodes. In other instances, other formats of data presentation may be preferred (e.g. linked lists, tables, etc.). A graph database 30 is a database whose records are not arranged according to a pre-determined structure or schema, but rather as nodes in a graph and edges between the nodes. Put another way, the graph database 30 is configured to store the records in a graph-like orientation, such that each record or object is a node in the graph and is said to be “connected” to another record or object by an edge if the object is somehow related to the other object. As used herein, the term “graph” does not require a visual representation of lines (a/k/a “edges”) that interconnect with points (a/k/a “nodes”). The term graph can include a set of nodes (e.g., objects or records representing objects) and edges connecting the nodes (e.g., relationships). Graphs can be directed graphs or undirected graphs. Additionally, graphs can be cyclic or acyclic. Further, graphs can be simple graphs or multigraphs. The graph can be a directed graph, a cyclic graph, or multigraph.

FIG. 2 illustrates an example of a plurality of database records (e.g., record 21, record 22, record 23 . . . record 29) stored in the graph database 30. For purposes of explanation, the illustrated records may collectively define a software development project. Each record stored in the graph database 30 respectively corresponds to an object, the collection of which defines the software development project. The graph database 30 further includes a plurality of edges (e.g., edge 31, edge 32, edge 33 . . . edge 39). Each edge defines a relationship between two nodes or objet. It is noted that a software development project may include thousands or millions of objects and each object may have a multitude of relationships with other objects.

Each record stores data regarding one of the objects. The data that is stored in the record can include a definition of the object. The definition of the object can include a type of the object (e.g., whether the object is a function, parameter, or test case, a unique identifier that identifies the object from the other object, and/or a name of the object). The graph database 30 may further store a set of relationships of the software development project. Each relationship may be a tuple (e.g., an ordered pair), such that each relationship is defined as an edge between two objects or nodes. Thus, each relationship may be thought of as an edge in the graph. A relationship can further include a type definition, which defines the type of relationship between two objects. In some implementations, the graph database 30 is arranged as a directed graph, such that each edge defines a “direction” of influence. Thus, if an edge is directed from a first object to a second object, then the first object is said to influence the second object. Furthermore, each relationship can be assigned a value indicating a type of the relationship. Examples of types of relationships include “results in” (e.g., function X results in parameter B), “uses” (e.g., function X uses parameter A), and “contains” (e.g., subsystem A contains function X). The graph database 30 may store other suitable data.

FIG. 3 illustrates an example implementation of the system integration server 10. The system integration server can include a processing device 100 that executes one or more of a database management module 110, a visualization module 120, and a version control module 130. The system integration server 10 further includes the graph database 30 and the revision database 40, which are stored on a storage device 102 (e.g., hard disk drive, optical disk drive, and/or flash drive). While, the database 30 and the revision database 40 are illustrated as being stored on the same storage device 102, the respective databases 30, 40 can be stored at different hosts, may be redundantly stored at multiple hosts, and may be stored at one or more of the computing devices 20. The integration server 10 may include additional components, such as a network interface device 104 that sends data to and receives data from the N computing devices 20 via a network 50 (e.g., an intranet and/or the Internet).

The processing device 100 includes one or more processors and one or more computer-readable mediums (e.g., read only memory and/or random access memory) that store computer-readable instructions that are executed by the one or more processors. In implementations where the processing device 100 includes two or more processors, the processors can execute in a distributed or individual manner. The database management module 110, the visualization module 120, and the version control module 130 may be implemented as computer readable instructions that are executed by the processing device 100.

The database management module 110 manages the graph database 30. The database management module 110 can create and update the graph database 30. The database management module 110 receives artifacts from remote computing devices 20 and identifies objects therein. As the database management module 110 parses the artifacts, it identifies references of objects in the artifact. When a reference is found, the database management module 110 assess the usage type as well as any existing dependencies in the referenced object and updates the graph database 30 with the corresponding record (i.e., node and edge). The database management module 110 may further identify relationships between the objects. The database management module 110 generates records corresponding to the identified objects and updates the graph database 30 with the new records and the identified relationships. As the database management module 110 creates the structure of the graph database 30 based on the contents of the artifacts, the database management module 110 can create the graph database 30 without a priori knowledge of the software development project. The database management module 110 may be wholly or partly implemented at the client computing device 20 instead of at the server 10.

In some implementations, the database management module 110 can record time instances corresponding to the objects. A time instance can be a node type which itself can be connected to any other node that participated at the time indicated by the time instance. Put another way, if a node is not connected via an edge to a particular time instance node, then the node was not relevant at the time indicated by the particular time instance node. If a node is connected via an edge to a particular time instance node, then the node was relevant at the time indicated by the particular time instance node.

The database management module 110 is configured to manage data objects and software artifacts in a centralized manner. Rather than implementing copies of shared data objects, artifacts that employ such objects can use a unique object reference that can be traced back to a unique object implementation. The unique implementation of the object, in turn, is managed via the database management module 110. In this way, any change to the object can be propagated into any eligible artifact.

The visualization module 120 receives requests to provide a view of an object and the objects related thereto. The visualization module 120 can determine other objects that are directly and indirectly related to the visualization module 120 based on the graph database 30. The visualization module 120 can then generate an analysis model based on the object and the related objects. The visualization module 120 can provide the analysis model to the requestor for display. The analysis model can be provided in, for example, a visual graph or in a report format. The visualization module 120 provides traceability and dependency visualization. The visualization module 120 may be wholly or partly implemented at the client computing device 20 instead of at the server 10.

The version control module 130 maintains the revision history of the software development project. In some implementations, the version control module 130 executes Apache Subversion, a similar program, or a modification of Apache Subversion. The version control module 130 may be further configured to maintain the state of each object in the software development project and can update the revision history database 40 each time an object is changed. In this way, the version control module 130 can identify when each particular object was changed with respect to other objects in the software development project. It is noted that the version control module 120 may be wholly or partly implemented at the client computing device 20 instead of at the server 10.

Referring now to FIG. 4, an example method 200 for creating or updating the graph database 30 is illustrated. At operation 212 the database management module 110 receives one or more artifacts. The database management module 110 can receive the artifacts from one or more of the computing device 20. At operation 214, the database management module 110 extracts a plurality of objects from the artifacts. The database management module 110 can implement text mining, heuristics techniques, and/or rules-based inferences to extract the various objects. When an object is extracted, the database management module 110 can classify the type of the object (e.g., parameter, signal, function, or subsystem). The database management module 110 can classify the type of the object using rules-based inferences, text mining, and/or a parser.

At operation 216, the database management module 110 creates a record for each identified object. The database management module 110 can create a record in any suitable manner. For instance, the database management module 110 may use a template to create the record. The database management module 110 can populate fields of the record with information it obtained when parsing the artifact (e.g., the type of the object). The database management module 110 may further generate a unique identifier for the record and associate with the record.

At operation 218, the database management module 110 can identify the relationships between the various objects. The database management module 110 parses an object to identify any references to any other objects. For example, a function FOO may receive the variable BAR or call another function BAZ. While parsing an object, the database management module 110 can identify the type of the other object and/or the relationship between the object and the other object. For example, if the object is a function and the other object is an input parameter, the database management module 110 can determine that the object has a “uses” relationship with the other object. Similarly, if the object is a function and the other object is a callee function, the database management module 110 can determine that the object has a “calls” relationship with the other object. Additionally or alternatively, a user may be allowed to explicitly define the relationship between objects. For each identified relationship, the database management module 110 can store a tuple indicating the related objects in the set of relationships. Furthermore, the database management module 110 can associate a type of the relationship with the tuple.

After the database management module 110 has created the records, the database management module 110 can store the records and the relationships in the graph database 30. In this way, the objects are linked in the graph database by the set of relationships. Further, in some implementations, the database management module 110 can create a time instance node that is indicative of a time that the method is executing and can link the time instance node 110 to any of the records that were created and/or updated during execution of the method.

As the database management module 110 creates records and identifies relationships, the database management module 110 can identify portions (“subgraphs”) of the software development project that overlap. The database management module 110 can merge these subgraphs by determining a union set of the objects and their respective relationships. In this way, duplicative records and/or relationships in the graph database 30 may be avoided. Furthermore, the database management module 110 is able to construct the graph database 30 in this manner without a priori knowledge of the structure or objects of the software development project.

The method 200 of FIG. 4 is provided for example only and is not intended to be limiting. Variations of the method are contemplated and are within the scope of the disclosure.

FIG. 5 illustrates an example method 300 for providing an analysis report. At operation 312, the visualization module 120 can receive a request for an analysis report. The request can be to view a specific object with respect to a portion of the analysis model. For instance, the visualization module 120 may receive the request from a computing device 20 to view a specific object and the portion of the software model that is directly related to the specific object or within two degrees of separation from the specific object. Alternatively or additionally, the request can be more specific and may define a question, such as “which subsystems use the signal X?” The visualization module 120 can break such a question down into an answerable question, such as which subsystems have a relationship, either direct or indirect, to signal X.

At operation 314, the visualization module 120 retrieves relationships in the graph database 30 corresponding to the specific object or objects that were expressed in the request. The visualization module 120 can query the graph database 30 to obtain any relationships that include a reference to the object or objects defined in the request. At operation 316, the visualization module 120 determines a set of related objects that have a relationship to the specific object. The visualization module 120 can traverse the edges of a specific object to identify the objects to which it is connected. The visualization module 120 can iteratively traverse the edges of the related objects to find second order, third order . . . Nth order relationships to the specified objects until a suitable portion of the software development project has been identified. The visualization module 120 can traverse the edges using a breadth-first or a depth-first approach. Upon determining all relevant objects and their respective relationships, the visualization module 120 can create a subgraph based on the determined objects, which can be transformed into a graph. The visualization module 120 can perform techniques such as merging to create the subgraph.

At operation 318, the visualization module 120 generates an analysis model based on the specific object or objects, the identified relationships, and the set of related objects. In some implementations, the visualization module 120 can generate the analysis model by rendering a visual graph that can be displayed by the requesting device. Alternatively or additionally, the visualization module 120 can generate the analysis model by generating a report defining a list of the objects and their connections to the requesting device, such that the objects and their connections can be displayed in, for example, a report format. Moreover, the report can be returned for more complex analysis at the computing device 20. Depending on the contents of the request, the visualization module 120 can perform various transformations to the subgraph to generate an analysis model that is relevant to the request. Examples of transformations include, but are not limited to, Node-to-Edge conversion, Edge-to-Node conversion, Edge aggregation, Node aggregation, Node creation, Edge creation, Node removal, and Edge removal. At operation 320, the visualization module 120 provides the analysis model for display by the requesting device.

The method of FIG. 5 is provided for example only and is not intended to be limiting. Variations of the method are contemplated and are within the scope of the disclosure. For example, the visualization module 120 may be further configured to leverage the revision history of the objects to provide previous states of the software development project.

It is noted that one or more of the database management module 110, the visualization module 120, and the revision module 130 can be implemented wholly or in part at the computing devices 20. Similarly, the revisions database 40 and the graph database 30 may be stored in multiple locations, including at the computing devices 20.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
generating, at a processing device, a graph database that stores a plurality of records representing a plurality of objects in a software development project, each record in the graph database representing an object in the software development project and being a node in a graph, the graph database further storing a set of relationships, each relationship defining an edge between two related objects;
receiving, at the processing device, a request for an analysis report corresponding to a specific object with respect to at least a portion of the software development project;
identifying, at the processing device, one or more relationships of the specific object based on the set of relationships;
determining, at the processing device, a set of related objects that have a relationship to the specific object based on the identified relationships;
generating, at the processing device, the analysis model based on the specific object, the identified relationships, and the set of related objects; and
providing, at the processing device, the analysis model.

2. The method of claim 1, wherein each relationship in the set of relationships defines a type of the relationship between the two related objects.

3. The method of claim 1, wherein generating the analysis model includes rendering, at the processing device, a visual graph based on the specific object, the set of related objects, and the set of relationships, wherein each relationship is an edge in the graph model between two graphed objects.

4. The method of claim 3, wherein each relationship defines a type of the relationship and the type of each relationship is displayed in the visual graph.

5. The method of claim 1, wherein identifying the one or more relationships includes:
identifying, at the processing device, a specific relationship of the specific object based on the set of relationships;
identifying, at the processing device, a directly related object indicated by the specific relationship; and
traversing, at the processing device, other relationships of the directly related object to identify indirectly related objects of the specific object, the other relationships being included in the one or more relationships.

6. The method of claim 1, wherein identifying the one or more relationships includes:
identifying, at the processing device, one or more specific relationships of the specific object;
identifying, at the processing device, one or more directly related objects based on the one or more specific relationships; and
iteratively traversing, at the processing device, other relationships of the directly related objects to identify any indirectly related objects in the portion of the software development projects.

7. The method of claim 6, wherein the analysis report is based on the one or more specific relationships, the one or more directly related objects, the one or more other relationships, and the indirectly related objects.

8. The method of claim 1, wherein creating the graph database includes:
receiving, at the processing device, one or more artifacts;
extracting, at the processing device, a plurality of objects from the artifacts; and
for each object:
a) parsing, at the processing device, the artifact to identify a reference to another object;
b) when a reference to the other object is identified, including, at the processing device, a new relationship between the object and the other object in the set of relationships.

9. The method of claim 1, wherein each object and relationship in the graph database is respectively assigned a unique identifier.

10. The method of claim 1, wherein creating the graph database includes:
determining, at the processing device, a first plurality of objects and a first plurality of relationships corresponding to a first portion of the software development project and a second plurality of objects and a second plurality of relationships corresponding to a second portion of the software development project;
determining, at the processing device, a union set of objects of the first plurality and the second plurality of objects, such that there are no duplicate objects in the union set of objects; and
determining, at the processing device, a union set of relationships based on the first and second pluralities of relationships, such that there are no duplicate relationships in the union set of relationships,
wherein the graph database comprises the union set of objects and the union set of relationships.

11. The method of claim 1, wherein the specific object represents one of a signal, parameter, a requirement, a feature, a test suite, a test case, a test case waveform, a test harness, a model, a model subsystem, a model block, a file, a statement, a function, a declaration, a definition, a user identity, and a time instance.

12. The method of claim 1, wherein the specific object is a time instance and the relationships between the time instance and the other objects indicates that the other objects were relevant to the software development project at a time corresponding to the time instance.

13. The method of claim 1, further comprising:
receiving, at the processing device, a second request to view a previous state of specific object;
retrieving, at the processing device, a revision history indicating a current state of and a set of changes that have been made to one or more of the objects including the specific object;
determining, at the processing device, the previous state of the specific object and the set of related objects based on the revision history;
generating, at the processing device, the second analysis model indicative of the state based on specific object and the set of related objects at the previous state; and
providing, at the processing device, the second analysis mode.

14. The method of claim 1, wherein generating the analysis model includes:
generating, at the processing device, a subgraph based on the specific object, the identified relationships, and the set of related objects;
performing, at the processing device, one or more transformations on the subgraph to obtain another subgraph based on the contents of the request.

15. The method of claim 14, wherein the one or more transformations are selected from the group including: Node-to-Edge conversion, Edge-to-Node conversion, Edge aggregation, Node aggregation, Node creation, Edge creation, Node removal, and Edge removal.

16. The method of claim 1, wherein the software development project is a development and testing of a real-time vehicle control system.
